(19) United States
(12) Patent Application Publication
(10) Pub. No.: US 2003/0154225 A1
(43) Pub. Date: Aug. 14, 2003

(54) Method for determining Hopf bifurcation points of a periodic state description of a technical system; computer program and computer program product executing the method; storage medium, computer memory, electric carrier signal, and data carrier storing the computer program; and method for downloading a computer program containing the method

(76) Inventor: Rolf Neubert, Unterhaching (DE)

Correspondence Address: LERNER AND GREENBERG, P.A., POST OFFICE BOX 2480, HOLLYWOOD, FL, 33022-2480, US

(21) Appl. No.: 10/365,039

(22) Filed: Feb. 12, 2003

(30) Foreign Application Priority Data
Feb. 12, 2002 (DE) 102 05 916.0

(51) Int. Cl. G06F 7/38

(52) U.S. Cl. 708/446

(57) ABSTRACT

A transfer function is formed starting from a technical system described by a system of parameter-dependent differential algebraic equations. Subsequently, information about the number of turns per unit length and about the monotonicity behavior of this transfer function is derived. It is established by using this information whether a Hopf bifurcation point is present. In the case of the presence of a Hopf bifurcation point, the latter is determined.

### BACKGROUND OF THE INVENTION

### FIELD OF THE INVENTION

The invention relates to a method for determining Hopf bifurcation points when determining a periodic state description of a technical system, and to the use thereof. A multiplicity of technical systems, in particular electric circuits, are subject to oscillations in different states. Such technical systems can be described by systems of differential algebraic equations. The aim for these technical systems is to determine both stationary and periodic solutions in order to be able to supply a periodic state description of the technical system.

A so-called QZ method is known that carries out a calculation of all the eigenvalues of the fundamental eigenvalue problem. This method is of cubic complexity in the dimension of the basic technical system and presupposes a very large storage space as well as a very fast computing time. This method is therefore unsuitable for large technical systems.

Methods that are based on iterative eigenvalue solvers are also known. However, it has so far not been possible to use these successfully, because they supply inaccurate solutions.

### SUMMARY OF THE INVENTION

It is accordingly an object of the invention to provide a method for determining Hopf bifurcation points of a periodic state description of a technical system; a computer program and a computer program product executing the method; a storage medium, a computer memory, an electric carrier signal, and a data carrier storing the computer program; and a method for downloading a computer program containing the method that overcome the hereinafore-mentioned disadvantages of the heretofore-known devices of this general type and that determine periodic solutions of a technical system, specifically the determination of Hopf bifurcation points, with high efficiency and reliably.

With the foregoing and other objects in view, there is provided, in accordance with the invention, a technical system having oscillations given by a system of parameter-dependent differential algebraic equations of the following form:

f(x′(t),x(t),λ)=0.

Also given is the following function:

F(x,λ)=f(0,x,λ)=0

that describes the stationary solutions of the system.

The first step is to calculate a bifurcation diagram of the solutions to F(x,λ)=0.

The determination of a Hopf bifurcation point constitutes an important part in calculating periodic solutions of a technical system having oscillations. A stationary solution or a DC operating point, as well as a technical system lose stability at Hopf bifurcation points, and a stable oscillation sets in. A branch of periodic solutions originates from a branch of the stationary solution in this case.

Hopf bifurcation points are detected numerically by demonstrating a change in sign of the real part for a complex conjugate pair of eigenvalues. This pair of eigenvalues can be derived from the eigenvalue problem using the Hopf lemma, which considers the Jacobi matrices at a stationary point. The value of the imaginary part of the eigenvalues corresponds to the frequency of the oscillation in a neighborhood of the Hopf bifurcation point. A periodically stationary state can be obtained in the neighborhood of the Hopf bifurcation point from the eigenvalue analysis, and the solution in the desired operating range can be obtained by varying the parameters used.

A so-called QZ method is known that carries out a calculation of all the eigenvalues of the fundamental eigenvalue problem. This method is of cubic complexity in the dimension of the basic technical system and presupposes a very large storage space as well as a very fast computing time. This method is therefore unsuitable for large technical systems.

Methods that are based on iterative eigenvalue solvers are also known. However, it has so far not been possible to use these successfully, because they supply inaccurate solutions.

The determination of the bifurcation diagram and of the Hopf bifurcation points is known from documents [1], [2] or [3].

The next step in the method according to the invention is to select a specific value for the continuation parameter λ. The Jacobi matrices C, G are calculated in the subsequent step. This calculation is known from document [4].

The function:

\tilde{g}(z)=c^{T}(G+zC)⁻¹b

is set up subsequently. In this case, b and c are randomly selected orthonormalized vectors that, however, may not lie in the left-hand or right-hand core of C. \tilde{g}(z) is a fractional rational function with real coefficients.

The constant term g_{∞} is separated from this function \tilde{g}(z). This is performed by using polynomial division. The result is therefore:

\tilde{g}(z)=g_{∞}+g(z).

This separation is known to the person skilled in the art. g(z) is considered below instead of \tilde{g}(z). g(z) has the same pole points as \tilde{g}(z) and likewise real coefficients, but vanishes at infinity. That information about the poles which explains the eigenvalues can be filtered out by parallel evaluation of g(z) with different, fixed random vectors b, c. Eigenvalues are a measure of the stability and can be calculated from the zeroes of the denominator. An evaluation of g is performed along the imaginary axis, it being assumed on grounds of continuity that no eigenvector has a real part with the value 0, that is to say g(ik) is calculated continuously for all vectors b,c in parallel, starting with k₀=0 for rising values of kER until |g(ik)| becomes sufficiently small. Here, i denotes the imaginary unit. The number of turns per unit length WZ is taken into account in this case, as is the monotonicity behavior of the function g(ik).

The turn function W of the function g(ik) is yielded as follows:

W(g(ik);k₀,k₁)=arg(g(ik₁))−arg(g(ik₀)).

The function arg is the angular function. In the case of convergence, the result is the number of turns per unit length WZ, that is to say the limiting value of the turn function W, as follows:

$$WZ = W ( g ( ik ) ; 0 , ∞ ) = {lim}_{k \to ∞} a r g ( g ( ik ) ) - arg ( g ( 0 ) ) .$$

A relationship between the number of turns per unit length WZ and the number of the zeroes and pole points can be derived mathematically by the Gaussian integral theorem. The result is the following:

$$W ( g ( ik ) ; 0 , ∞ ) = ( {N}_{l} - {N}_{r} + {P}_{r} - {P}_{l} ) \frac{π}{2} .$$

Here, N₁, Nᵣ, P₁ and Pᵣ denote the number of the zeroes and pole points in the right-hand and left-hand half plane, respectively, counted in accordance with their orders of multiplicity.

The number of turns per unit length WZ of the function g(ik) is calculated correspondingly for fixed random vectors b, c in relation to various continuation parameters λ. The result obtained is an overview of the behavior of the zeroes and pole points of g(ik) during a continuation.

If a complex conjugate pair of pole points traverses the imaginary axis, the number of turns per unit length WZ consequently changes by ±2π. Consequently, Hopf bifurcation points can be identified by analyzing the number of turns per unit length WZ in the course of a continuation, that is to say they can be identified for increasing continuation parameters λ.

The monotonicity behavior of the real part R(g(ik)) of the function g(ik) is determined in a further step of the method according to the invention.

Use is made in this case of the circumstance that the traversal of the imaginary axis by a complex conjugate pair of eigenvalues causes a local minimum in the real part R(g(ik)) of the function g(ik) to change into a local maximum in a neighborhood of the Hopf bifurcation point. Consequently, examining the real part R(g(ik)) as a function of varying continuation parameters λ provides information as to whether a Hopf bifurcation point has been missed. In particular, a Hopf bifurcation point is present, in particular, when the slope or the first derivative of the real part R(g(ik)) of the function g(ik) exhibits a change in sign for sequential parameter values of λ.

The number of turns per unit length WZ and the change in the monotonicity behavior of the real part R(g(ik)) are logged for varying continuation parameters λ during the execution of the method according to the invention. This information is used to establish in the step now following whether a Hopf bifurcation point has been found. Use is made in this case of the information from the numbers of turns per unit length WZ and their relationship between the zeroes N and the pole points P of g(ik), and of the information about the monotonicity behavior of R(g(ik)).

If a Hopf bifurcation point has been found, the frequency of the oscillation in the neighborhood of the Hopf bifurcation point is determined. The method according to the invention is ended at this point with the determination of the Hopf bifurcation point.

If no Hopf bifurcation point has been found, it is checked whether the parameter λ has reached a specific value λₘₐₓ that can be prescribed by a user. The method according to the invention is likewise ended if this is the case.

If no Hopf bifurcation point has been found, and if λ has not yet reached the value λₘₐₓ, the method according to the invention is repeated from the step of determining a value for the parameter λ.

A basic idea of the invention involves evaluating the function g(ik) instead of undertaking a calculation of all the eigenvalues.

In accordance with a further object of the invention, the method for determining Hopf bifurcation points by analyzing the number of turns per unit length is combined with the method for determining Hopf bifurcation points by considering monotonicity to form a common method, and in using the synthesis of the two methods to make available a highly efficient and robust detection of Hopf bifurcation points.

The inventive evaluation of the function \tilde{g}(z)=c^{T}(G+z^{C})⁻¹ b corresponds to the solution of a system of linear equations. It follows that this evaluation exhibits only weakly superlinear complexity for the Jacobi matrices G and C, generally very thinly occupied, of the technical system under examination.

The method according to the invention for determining Hopf bifurcation points consequently exhibits a complexity of O(n⁶⁰), α≈1. The complexity is O(n³) in the case of the known methods. Consequently, the inventive method operates with particular efficiency from n≈200, and for n≈1000 the speed ups are already at a value of approximately 100. The inventive method can therefore be applied advantageously even for relatively large circuits for which the known QZ methods fail.

In accordance with one embodiment of the invention, the monotonicity behavior of the real part R(g(ik)) of the function g(ik) is determined by an extreme value investigation of R(g(ik)) for varying values of the continuation parameter λ.

If a complex conjugate pair of eigenvalues traverses the imaginary axis between two continuation parameters λ₀ and λ₁, that is to say a Hopf bifurcation point lies between λ₀ and λ₁, a local minimum or maximum in the real part R(g(ik)) of the function g(ik) changes at the parameter value λ₀ into a local maximum or minimum at the parameter value λ₁. Consequently, this criterion also serves for characterizing Hopf bifurcation points. The criterion that the sign of the derivative of the real part R(g(ik)) of the function g(ik) changes locally in the neighborhood of the extreme value is equivalent, but easier to check.

The examination of the function g(ik) consequently supplies two criteria for detecting a Hopf bifurcation point: firstly, a change in the number of turns per unit length by ±2π and, secondly, a change in the extreme value behavior. Hopf bifurcation points can be found reliably and efficiently by combining the two criteria.

In accordance with a further embodiment of the invention, the frequency of the oscillation in the neighborhood of a Hopf bifurcation point is determined. The location kₘ at which the real part R(g(ik)) has its steepest gradient is selected as an approximation for the frequency. For this purpose, the slope of the secant of R(g(ik)) through the points

$$( {k}_{m} , g ( ik ) ) , ( {k}_{m - 1} , g ( {ik}_{m - 1} ) ) , that is to say ( \frac{g ( {ik}_{m} ) - g ( {ik}_{m - 1} )}{{k}_{m} - {k}_{m - 1}} )$$

is examined for its maximum magnitude. The actual eigenvalue is calculated by an inverse iteration starting from this approximation. This method is known to the person skilled in the art. It is possible on this basis to apply the methods known from document [3] to calculate periodic solutions.

Starting from an approximation, this embodiment of the invention can be used to determine a periodic solution in the neighborhood of a Hopf bifurcation point reliably and accurately.

A further embodiment of the invention provides that the inventive method is carried out inversely for intermediate values when no reliable statement can be made on the presence of a Hopf bifurcation point.

In this case, the method steps are repeated from the determination of a value for the parameter λ. A value is selected for the parameter λ that lies between the value of the parameter λ selected last, and that selected last but one. The new parameter λ can also be provided as the arithmetic mean of the value of the parameter λ selected last and that selected last but one. Calculations are conducted on both sides starting from the newly selected value for the parameter λ, specifically in the direction of the last, selected value for the parameter λ and in the direction of the last but one, selected value of the parameter λ. Moreover, when evaluating the function g(ik) it is possible to match the sampling individually. A particularly reliable and particularly fine determination of a Hopf bifurcation point is thereby possible.

The invention also relates to a method in which the basic technical system has at least one electric circuit or is present as an electric circuit, in particular as an autonomous electronic circuit.

The invention also relates to the use of the inventive method as claimed in one of the preceding claims for simulating electric circuits.

The invention is also implemented in a computer program for executing a method for determining Hopf bifurcation points of a periodic state description of a technical system. The computer program is configured in this case such that a method in accordance with one of the inventive claims is implemented by a system of differential algebraic equations after the technical system has been input. In this case, Hopf bifurcation points of a periodic state description of the technical system can be output as a result of the method. These Hopf bifurcation points can be used very advantageously to make statements on the basic technical system.

The improved computer program according to the invention results in a reliable and complete determination of the Hopf bifurcation points and in an improvement in transit time by comparison with known methods for determining Hopf bifurcation points of technical systems.

The invention also relates to a computer program that is contained on a storage medium, that is stored in a computer memory, that is contained in a random-access memory or that is transmitted on an electric carrier signal. The invention also relates to a data carrier having such a computer program and to a method in which such a computer program is downloaded from an electronic data network such as, for example, from the Internet onto a computer connected to the data network.

Other features that are considered as characteristic for the invention are set forth in the appended claims.

Although the invention is illustrated and described herein as embodied in a method for determining Hopf bifurcation points of a periodic state description of a technical system; a computer program and a computer program product executing the method; a storage medium, a computer memory, an electric carrier signal, and a data carrier storing the computer program; and a method for downloading a computer program containing the method, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### BRIEF DESCRIPTION OF THE DRAWINGS

FIG. 1 is a flowchart illustrating a method according to the invention for determining Hopf bifurcation points of a periodic state description of a technical system;

FIG. 2 is a circuit diagram showing a fully integrated voltage-controlled oscillator;

FIG. 3 is bifurcation diagram of the system of differential algebraic equations that describes the voltage-controlled oscillator shown in FIG. 2; and

FIG. 4 is a graph plotting the real part profile of a function g(ik) with a first real part profile, a second real part profile, and a third real part profile of the voltage-controlled oscillator shown in FIG. 2.

### DESCRIPTION OF THE PREFERRED EMBODIMENTS

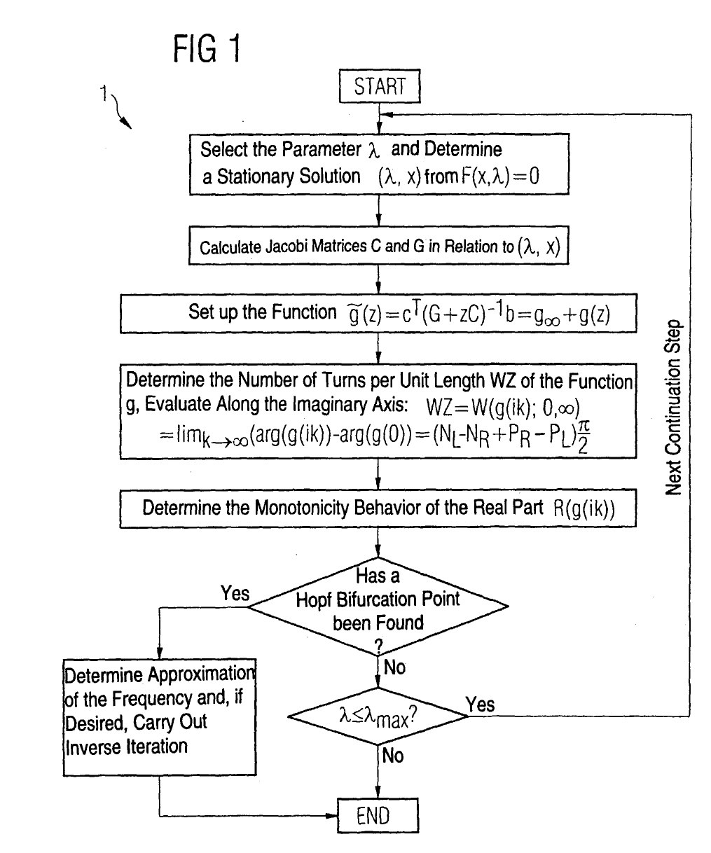

Referring now to the figures of the drawings in detail and first, particularly to FIG. 1 thereof, there is shown a flowchart 1 of the method for determining Hopf bifurcation points of a periodic state description of a technical system.

The method according to the invention proceeds from a system of parameter-dependent differential algebraic equations of the form f(x′(t), x(t), λ)=0. In this case, the solutions of the algebraic equation F(x,λ)=f(0,x,λ)=0 are examined for the purpose of determining Hopf bifurcation points.

The solutions of F(x,λ)=0 for a varying parameter λ are examined with the aid of so-called continuation methods. How to carry out continuation methods is known from documents [1], [2] or [3].

The actions during a continuation step, that is to say for a fixed λ, are described below. After determining the value for λ, the associated stationary solution (λ,x) is determined by solving F(x,λ)=0.

Thereupon, the linearization by the solution, that is to say the Jacobi matrices C=fₓ(0,x,λ) and G=fₓ(0,x,λ), is calculated. This calculation is known from document [4].

In a further step of the method, a function \tilde{g}(z)=c^{T}(G+zC)⁻¹ b is set up. In this case, b and c are orthonormalized random vectors. \tilde{g}(z) is a fractional rational function with real coefficients.

The matrices are usually only weakly occupied when calculating periodic solutions for large systems. The outlay for evaluating \tilde{g}(z) therefore generally has an only weakly superlinear complexity. \tilde{g}(z) has the eigenvalues of the equation

G(λ₀)υ(λ₀)+μ(λ₀)C(λ₀)υ(λ₀)=0

as pole points. This follows from Cramer's rule, which is described in document [5].

The degree of the numerator of \tilde{g}(z) is a function of the rank and of the structure of the Jacobi matrix C. This follows from the adjunct matrix and the Laplace expansion, which is described in document [5].

By contrast with the pole points, the zeroes are a function of the selection of orthonormalized random vectors b, c. The Jacobi matrix C has full rank only when the system of parameter-dependent differential algebraic equations:

f(x′(t),x(t),λ)=0

is an implicit, ordinary differential equation. This is not the case with many technical systems present as circuits. The Jacobi matrix C is normally singular here. Consequently, it is permissible to assume that the degree of the numerator and that of the denominator are equal.

Consequently, the constant term g_{∞} of the function \tilde{g}(z) is separated by polynomial division:

\tilde{g}(z)=g_{∞}+g(z).

This separation is known to the person skilled in the art.

In this case, the limiting value g_{∞}=lim\tilde{g}(z) for z→∞ corresponds to the limiting value of \tilde{g}(z) with respect to infinity. g(z) is considered below instead of \tilde{g}(z). g(z) has the same pole points as \tilde{g}(z), and likewise has real coefficients. However, g(z) vanishes at infinity.

In the next step of the method according to the invention, the number of turns per unit length WZ of the function g is evaluated along the imaginary axis, that is to say g(ik) is calculated. An overview of the behavior of the zeroes and of the pole points of g(ik), and thus of the behavior of the eigenvalues during a continuation is obtained from the calculation of the number of turns per unit length WZ of the function g(ik) for fixed random vectors b, c relating to different continuation parameters λ.

It is possible to distinguish between double zeroes and pole points from the knowledge as to whether the fundamental system is moving from the stable into the unstable state, or from the unstable into the stable state. Further knowledge of the pole points and of the zeroes results from a parallel calculation of the numbers of turns per unit length WZ in relation to different vectors b, c. Thus, pole points and zeroes can be distinguished, and Hopf bifurcation points can be identified.

The turn function W is defined as follows:

W(g(ik);k₀,k₁)=arg(g(ik₁))−arg(g(ik₀)).

In the case of a convergence, the number of turns per unit length WZ is yielded as:

$$WZ = W ( g ( ik ) ; 0 , ∞ ) = {lim}_{k \to ∞} a r g ( g ( ik ) ) - arg ( g ( 0 ) ) .$$

The relationship between the number of turns per unit length WZ and the number of zeroes and pole points is yielded as follows, given the first presupposition that g provides a rational function, the degree of whose numerator is less than the degree of the denominator, and given the second presupposition that no zero N and no pole point P of g has a real part with the value 0:

$$WZ = W ( g ( ik ) ; 0 , ∞ ) = ( {N}_{l} - {N}_{r} + {P}_{r} - {P}_{l} ) \frac{π}{2} .$$

Here, N₁, Nᵣ, P₁ and Pᵣ denote the number of the zeroes N and of the pole points P in the right-hand and the left-hand half plane, respectively, counted in accordance with their orders of multiplicity.

It is to be borne in mind, furthermore, that the changes are always present as an integral multiple of π when the number of turns per unit length WZ is determined. The traversal of the imaginary axis by a complex conjugate pair of eigenvalues or by a complex conjugate pair of zeroes is detected by a change of ±2π in the number of turns per unit length. The traversal of the imaginary axis by single zeroes N or by single pole points P is indicated by a change of ±π in the number of turns per unit length WZ. Other differences in the numbers of turns per unit length WZ can be explained by the combination of these three cases.

The traversal of the imaginary axis by a complex conjugate pair of eigenvalues or by a complex conjugate pair of zeroes is evidence of the presence of a Hopf bifurcation point.

Owing to excessively large continuation steps in λ, mutually compensating traversals of the imaginary axis of zeroes and pole points can occur such that the criterion of the number of turns per unit length cannot be applied. For this reason, the monotonicity behavior of the real part R(g(ik)) of the function g(ik) is examined in the vicinity of local extremes in addition to the calculation of the numbers of turns per unit length.

If a complex conjugate pair of eigenvalues traverses the imaginary axis between two continuation parameters λ₀ and λ₁, that is to say if there is a Hopf bifurcation point between λ₀ and λ₁, a local minimum or maximum in the real part R(g(ik)) of the function g(ik) at the parameter value λ₀ changes into a local maximum or minimum at the parameter value λ₁.

Consequently, this criterion also serves for characterizing Hopf bifurcation points. Equivalent, but easier to check is the criterion that the sign of the derivative of the real part R(g(ik)) of the function g(ik) changes locally in the neighborhood of the extreme value.

On the basis of the criteria of the number of turns per unit length WZ and of the extreme value behavior, a check is now made as to whether a Hopf bifurcation point has been found.

If this check has a negative result, a check is made as to whether the selected parameter λ has reached a value λₘₐₓ that can be prescribed by a user.

If the parameter λ has not yet reached the value λₘₐₓ, all the method steps are repeated starting from the step of selecting a new parameter λ.

If the selected parameter λ overshoots the prescribed value λₘₐₓ, the method according to the invention is ended. In this case, no Hopf bifurcation point has been detected.

In the case when the check as to whether a Hopf bifurcation point has been found yields a positive result, an approximation of the frequency of the oscillation in the neighborhood of the Hopf bifurcation point is determined and, if appropriate, an inverse iteration is carried out to determine the exact value for the frequency.

If no reliable statement on the presence of a Hopf bifurcation point can be made at this juncture, the method according to the invention is carried out inversely for intermediate values of the continuation parameter λ.

For the inverse iteration, the location kₘ at which R(g(ik)) has the steepest gradient is selected as approximation for the frequency of the oscillation.

For this purpose, the slope of the secant of R(g(ik)) through the points:

x(kₘ,g(ikₘ)), x(kₘ₋₁,g(ikₘ₋₁)),

that is to say the term

$$\frac{g ( {ik}_{m} ) - g ( {ik}_{m - 1} )}{{k}_{m} - {k}_{m - 1}}$$

is investigated for a maximum magnitude. The actual eigenvalue is calculated by an inverse iteration proceeding from this approximation. Periodic solutions of the basic technical system can be calculated on this basis with the aid of the methods from document [3].

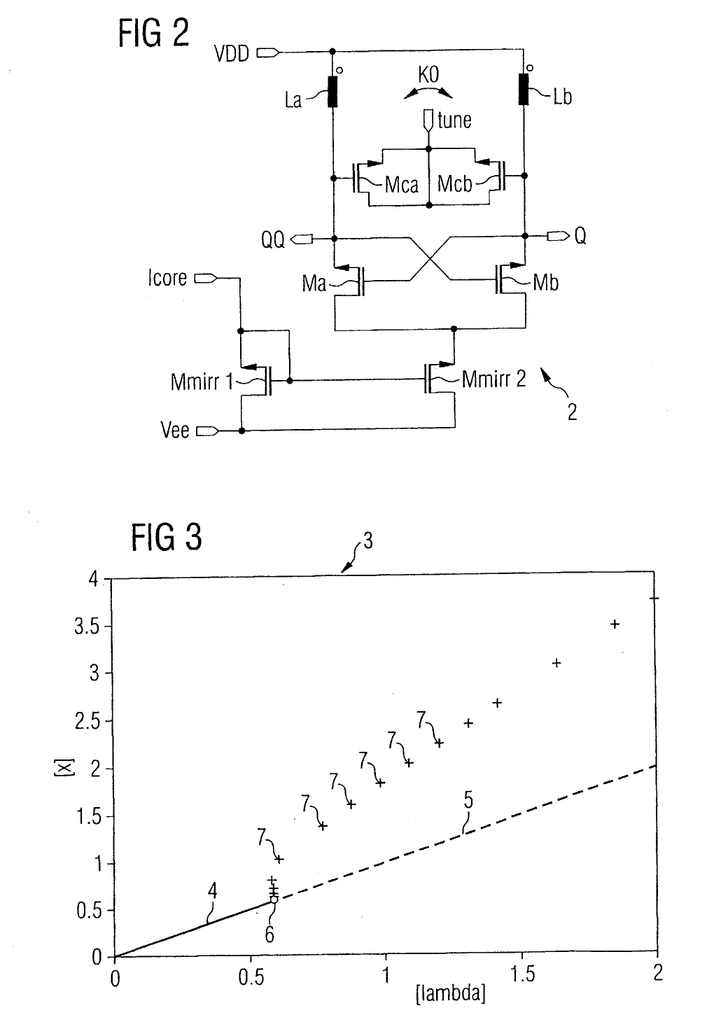

FIG. 2 shows a circuit diagram of a fully integrated voltage-controlled oscillator 2 in accordance with an exemplary embodiment.

The voltage-controlled oscillator 2 shown in FIG. 2 constitutes a system that assumes periodically recurring states and is used to generate oscillations, in particular radio-frequency oscillations in mobile radio.

With the incorporation of parasitic elements, the voltage-controlled oscillator 2 can be described by a system of 905 differential algebraic equations of the form:

f(x′(t),x(t),λ)=0.

For reasons of clarity, no attempt will be made to represent this system of differential algebraic equations.

A precise description of the configuration and the mode of operation of the voltage-controlled oscillator 2 is contained in document [6].

FIG. 3 shows a bifurcation diagram 3 of the system of differential algebraic equations that describes the voltage-controlled oscillator 2 shown in FIG. 2, in accordance with the exemplary embodiment.

The bifurcation diagram 3 has stable stationary solutions 4, unstable solutions 5, a Hopf bifurcation point 6 and periodic solutions 7.

Drawn in relation to each parameter λ in the bifurcation diagram 3 illustrated in FIG. 3 is a one-dimensional projection of the associated stationary or periodic solutions x of the system of equations that describes the voltage-controlled oscillator 2.

The curve represented as continuous symbolizes the set of the stable stationary solutions 4 of the fundamental system of differential algebraic equations of the voltage-controlled oscillator 2. The line of dashes constitutes the unstable stationary solutions 5 of the fundamental system of differential algebraic equations of the voltage-controlled oscillator 2. The periodic solutions 7 are represented by crosses. The point at which the branch of the periodic solutions 7 originates from the branch of the stable stationary solutions 4 is the Hopf bifurcation point 6. Furthermore, at the Hopf bifurcation point 6 the branch of the stable stationary solutions 4 merges into the branch of the unstable stationary solutions 5.

Examined in the bifurcation diagram 3 illustrated in FIG. 3 is the local dynamics of the solutions of the algebraic equation:

F(x,λ)=f(0,x,λ)=0

that is yielded from the parameter-dependent system of differential algebraic equations:

f(x′(t),x(t),λ)=0.

The solutions of F(x,λ)=0 are present as one-dimensional submanifolds, and frequently have a complicated structure. For example, a plurality of solutions can belong to one parameter λ, and the function F(x,λ)=0 can have singularities and forks.

In general, the calculation of the set of the stationary solutions of the function F(x,λ)=0 still does not yield a statement on the dynamic response of the fundamental system in a neighborhood of a stationary solution. A stability analysis is therefore carried out for each stationary solution. The set of the stationary solutions of the function F(x,λ)=0 are usually illustrated in a bifurcation diagram 3 in conjunction with information relating to the stability of the individual, stationary solutions. Consequently, it is possible to recognize in the bifurcation diagram 3 those critical ranges of the parameter k in the case of which a gain or a loss in the stability of the respective stationary solution of the function F(x,λ)=0 obtains.

In this invention, particular consideration is given to the loss of stability at so-called Hopf bifurcation points 6 at which a branch of periodic solutions originates from the branch of a stationary solution.

The execution of the numerical calculation of the Hopf bifurcation point 6 illustrated in FIG. 3 is performed in this exemplary embodiment in accordance with the mode of procedure of the method according to the invention.

For the system of differential equations that describes the voltage-controlled oscillator 2, the following method steps according to the invention are carried out in each step of the continuation method, the starting point being the bifurcation diagram 3 supplied:

determining a value for the parameter λ,

determining a stationary solution (x,λ) by solving F(x,λ)=0,

calculating the Jacobi matrices C, G,

setting up the function \tilde{g}(z)=c^{T}(G+zC)⁻¹ b,

separating the constant term g_{∞},

calculating the number of turns per unit length WZ of the function g, evaluated along the imaginary axis

$$WZ = W ( g ( ik ) ; 0 , ∞ ) = {lim}_{k \to ∞} a r g ( g ( ik ) ) - arg ( g ( 0 ) ) = ( {N}_{1} - {N}_{r} + {P}_{r} - {P}_{1} ) \frac{π}{2} ,$$

determining the monotonicity behavior of the real part R(g(ik)) of the function g(ik),

evaluating the criteria via the number of turns per unit length WZ and extreme value behavior, and thereby establishing whether a Hopf bifurcation point 6 has been found,

if a Hopf bifurcation point 6 has been found, determining an approximation for the frequency of the oscillation and, if appropriate, carrying out an inverse iteration,

if no Hopf bifurcation point 6 has been found, checking whether λ≦λₘₐₓ,

if no Hopf bifurcation point 6 has been found and if λ≦λₘₐₓ, repeating the steps from the step of determining a value for the parameter λ for the next continuation step.

For reasons of clarity, no attempt is made to represent the concrete execution of the individual method steps for the system of differential algebraic equations includes 905 differential algebraic equations that describes the voltage-controlled oscillator 2.

The result of the method according to the invention, specifically the Hopf bifurcation point 6, is illustrated graphically in FIG. 3.

The person skilled in the art can use the information contained in this document as well as the cited documents to conduct these method steps for determining Hopf bifurcation points for the system of differential algebraic equations that describes the voltage-controlled oscillator 2 and includes a total of 905 differential algebraic equations.

Hopf bifurcation points 6 are recognized numerically by virtue of the fact that a change in sign in the real part is demonstrated for a complex conjugate pair of eigenvalues, the eigenvalues having previously been calculated with the aid of the QZ method.

How to carry out the QZ method is known from document [8]. This requires approximately 30n³ operations per eigenvalue problem, and is thus a method of cubic complexity. The theorem included in document [7] can also be applied to determine the Hopf bifurcation point 6.

An efficient alternative that analyzes the number of turns per unit length is described in document [9] for ordinary differential equations of the form x′=f(x,λ).

Hopf bifurcation points 6 are frequently not recognized by the method for recognizing Hopf bifurcation points 6 by analyzing the number of turns per unit length, since the jumps in the number of turns per unit length WZ cancel one another out. This is the case, in particular, when the continuation parameter λ is sampled with an excessively large step width. It happens in this case that in one step both a pair of eigenvalues migrate from left to right, and a pair of zeroes migrate from right to left.

When the method according to the invention is used, a CPU (Central Processing Unit) time of 23.77 seconds is required to calculate a solution of the system of differential algebraic equations describing the voltage-controlled oscillator 2. The known QZ method requires a time interval of 1977 sec to calculate a solution of the same system of differential equations.

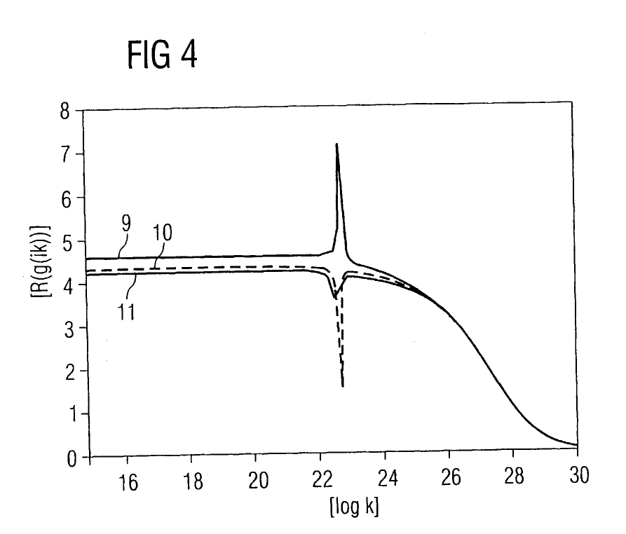

FIG. 4 shows an illustration 8 of the real part profile of a function R(g(ik)) having a first real part profile 9, having a second real part profile 10 and having a third real part profile 11 of the voltage-controlled oscillator 2 shown in FIG. 2 in accordance with the exemplary embodiment.

A statement as to whether a Hopf bifurcation point 6 has been missed can be made by examining the graph in FIG. 4 of the real part R(g(ik)) of the function g(ik). This examination of the real part of g(ik) is based on the following theorem.

The traversal of the imaginary axis by a complex conjugate pair of eigenvalues causes a local minimum (maximum) of the real part of the transfer function g(ik) to be changed into a local maximum (minimum) in a neighborhood of the Hopf bifurcation point 6.

In the two-dimensional graphic illustration 8 of the real part profile, log k is plotted with a value range of “15-30” on the horizontal axis, and the real part of R(g(ik)) is plotted with a value range of “0-8” on the vertical axis.

In FIG. 4, the first real part profile 9 is illustrated by a continuous line, the second real part profile 10 by a dashed line, and the third real part profile 11 by a finely dashed line.

For 15<logk<22, the first real part profile 9 has an approximately constant value of 4.6 for the real part R(g(ik)). For 22<logk<23.5, the first real part profile 11 has a strong excursion upward. The maximum magnitude of the first real part profile 11 is given at the point logk=22.7, R(g(ik) )=7.1.

The second real part profile 10 has a constant value R(g(ik))=4.7 in the range 15<logk<22. The second real part profile 10 has a strong excursion downward in the range 22<logk<23.5, and reaches its local minimum at the point logk=22.7, R(g(ik))=1.4.

The third real part profile 11 runs at a constant value of R(g(ik))=4.5 in the range 15<logk<22. In the range 22<logk<23.5, the third real part profile 11 has a local minimum at the value logk=22.4, R(g(ik))=3.5.

Starting from the value logk=23.5, the first real part profile 9, the second real part profile 10 and the third real part profile 11 drop continuously as far as the point logk=30, R(g(ik) )=0.2.

The local maximum of the first real part profile 9, the local minimum of the second real part profile 10 and of the third real part profile 11 in the range 22<logk<23.5 indicate the presence of a Hopf bifurcation point 6. Evidently, the Hopf bifurcation point 6 is disposed between the first real part profile 9 and the second real part profile 10 or between the first continuation parameter λ₁ and the second continuation parameter λ₂.

A consideration of the monotonicity behavior of the real part R(g(ik)) establishes that in the case of the first real part profile 9 there is a positive monotonicity before the local maximum, and thereafter a negative one. In the case of the second real part profile 10 and of the third real part profile 11, there is a negative monotonicity before the local minimum, and thereafter a positive one.

The following publications have been cited in the course of this document:

[1] Verfahren und Vorrichtung zur Bestimmung einer periodischen Zustandsbeschreibung eines technischen Systems, welches Schwingungen unterliegt, durch einen Rechner sowie deren Verwendung [Method and device for determining a periodic state description of a technical system subject to oscillations by means of a computer, and its use], 1996, German Patent No. DE 196 40 583 C1.

[2] R. Neubert, P. Selting, Q. Zheng, Analysis of autonomous oscillators: a multistage approach, in Mathematical theory of networks and systems. Proceedings of the MTNS-98 symposium, held in Padova, Italy, A. Beghi, L. Finesso, and G. Picci, eds., Padova, July 1998, Il poligrafo, pp 1055-1058.

[3] Q. Zheng, R. Neubert, Computation of periodic solutions of differential algebraic equations in the neighborhood of Hopf bifurcation points, Int. J. of Bifurcation and Chaos, 7 (1997), pp 2773-2788.

[4] I. N. Bronstein, K. A. Semendjajew, Taschenbuch der Mathematik [Manual of mathematics], pp 740-743.

[5] I. N. Bronstein, K. A. Semendjajew, Taschenbuch der Mathematik [Manual of mathematics], pp 150-159.

[6] M. Tiebout, A Fully Integrated 1.3 GHz VCO for GSM in 0.25 μm Standard CMOS with a Phase noise of −142 dBc/Hz at 3 MHz Offset, Proceedings 30th European Microwave Conference, Paris, 2000.

[7] E. Hopf, Abzweigung einer periodischen Lösung von einer stationären Lösung eines Differentialsystems [Branching of a periodic solution from a stationary solution of a differential system], Bericht der Math.-Phys. Klasse der Sächsischen Akademie der Wissenschaften zu Leipzig [Report of the Math.-Phys. Class of the Saxon Academy of Sciences at Leipzig], 94 (1942).

[8] G. H. Golub, C. F. van Loan, Matrix Computations, Johns Hopkins University Press, Baltimore, 1989.

[9] W. Govaerts, A. Spence, Detection of Hopf points by counting sectors in the complex plane, Numer. Math., 75 (1996), pp 43-58.

I claim:

1. A method for determining Hopf bifurcation points of a periodic state description of a technical system having oscillations and satisfying an equation:
f(x′(t),x(t),λ)=0,
which comprises the following steps:
a) determining a value for a parameter λ and calculating a stationary solution (x,λ) by solving
F(x,λ)=0,
b) calculating Jacobi matrices C, G,
c) setting up a function
\tilde{g}(z)=c^{T}(G+zC)⁻¹ b,
b, c being orthonormalized random vectors,
d) separating a constant term g_{∞}
\tilde{g}(z)=_{∞}+g(z),
e) calculating a number of turns per unit length WZ of a function g, evaluated along an imaginary axis:
$$WZ = W ( g ( ik ) ; 0 , ∞ ) = ( {N}_{1} - {N}_{r} + {P}_{r} - {P}_{1} ) \frac{π}{2} ,$$
f) determining a monotonicity behavior of a real part R(g(ik)) of a function g(ik),
g) determining if a Hopf bifurcation point has been found by using the numbers of turns per unit length WZ of the function g(ik), and by using the monotonicity behavior of the real part R(g(ik)) of the function g(ik):
if the Hopf bifurcation point has been found, determining an approximation for a frequency of an oscillation and, if appropriate, carrying out an inverse iteration for accurately determining an actual frequency,
if the Hopf bifurcation point has not been found, checking if λ≦λₘₐₓ, and
h) repeating steps a) to f) if the Hopf bifurcation point has not been found and if λ≦λₘₐₓ.

2. The method according to claim 1, wherein the approximation for the frequency of an oscillation in a neighborhood of the Hopf bifurcation point is location kₘ where a real part R(g(ik)) of the function g(ik) has a steepest gradient, the slope
$$\frac{g ( {ik}_{m} ) - g ( {ik}_{m - 1} )}{{k}_{m} - {k}_{m - 1}}$$
of the secant of the function g(ik) through points
kₘ, g(ikₘ)), (kₘ₋₁, g(ikₘ₋₁) )
being examined for a maximum magnitude.

3. The method according to claim 1, which further comprises:
repeating steps a) to f) if the Hopf bifurcation point has not been found in step g),
forming an arithmetic mean from a last and a second-to-last value of the parameter λ, and
selecting the arithmetic mean for a new parameter λ in step a).

4. The method according to claim 1, wherein the technical system has an electric circuit.

5. A method for simulating an electrical circuit, which comprises:
providing a technical system with an electrical circuit; and using the method according to claim 1 on the technical system having the electrical circuit.

6. A computerized method, which comprises executing the method according to claim 1 on a computer.

7. A computer-readable medium having computer-executable instructions for performing a method, which comprises the method according to claim 1.

8. A storage medium having computer-executable instructions for performing a method, which comprises the method according to claim 1.

9. A computer memory having computer-executable instructions for performing a method, which comprises the method according to claim 1.

10. The computer memory according to claim 9, wherein said computer memory is a random-access memory.

11. An electric carrier signal carrying computer-executable instructions for performing a method, which comprises the method according to claim 1.

12. A data carrier having computer-executable instructions for performing a method, which comprises the method according to claim 1.

13. A method for downloading a computer program for determining Hopf bifurcation points of a periodic state description of a technical system having oscillations and satisfying an equation:
f(x′(t), x(t),λ)=0,
which comprises:
providing an electronic data network;
connecting a computer to the network; and
downloading the computer program according to claim 6 from the electronic data network to the computer.

14. The method according to claim 13, wherein the electronic data network is the Internet.
